(19) United States
(12) Patent Application Publication
(10) Pub. No.: US 2015/0016996 A1
(43) Pub. Date: Jan. 15, 2015

(54) TELESCOPIC ROTOR BLADE AND TELESCOPIC TOWER, WIND TURBINE, AND WIND FARM

(71) Applicant: Rolf Rohden, Aurich (DE)

(72) Inventor: Rolf Rohden, Aurich (DE)

(21) Appl. No.: 14/369,196

(22) PCT Filed: Dec. 28, 2012
(86) PCT No.: PCT/DE2012/100402

§ 371 Date: Jun. 27, 2014

(30) Foreign Application Priority Data
Dec. 29, 2011 (DE) 10 2011 122 504.1

(51) Int. Cl. F03D 1/06; E04H 12/18; F16B 7/10; F03D 11/04

(52) U.S. Cl. CPC F03D 1/06; F03D 11/04; E04H 12/182; F16B 7/105
USPC 416/87; 52/111

(57) ABSTRACT

A rotor blade includes a first rotor blade section, a second rotor blade section, a control device, and a reset device. The control device is configured to displace the first rotor blade section and the second rotor blade section relative to each other so as to form a telescopic rotor blade which can adopt a minimum position, an intermediate position or a maximum position. The reset device is configured so that, when the control device experiences a functional limitation, the telescopic rotor blade assumes the minimum position.

CROSS REFERENCE TO PRIOR APPLICATIONS

This application is a U.S. National Phase application under 35 U.S.C. §371 of International Application No. PCT/DE2012/100402, filed on Dec. 28, 2012 and which claims benefit to German Patent Application No. 10 2011 122 504.1, filed on Dec. 29, 2011. The International Application was published in German on Jul. 4, 2013 as WO 2013/097847 A2 under PCT Article 21(2).

### FIELD

The present invention relates to a rotor blade with a first rotor blade section and a second rotor blade section, wherein the first rotor blade section and the second rotor blade section are designed to be movable relative to each other by means of a control device so that, for example, a telescopic rotor blade is formed and the rotor blade sections can adopt a minimum position, an intermediate position, or a maximum position when displaced, and a tower, for example, a wind turbine tower with a first tower section and a second tower section, wherein the first tower section and the second tower section are designed to be movable relative to each other so that, for example, a telescopic tower is formed and that the tower sections can adopt a minimum position, an intermediate position, or a maximum position when displaced. The present invention also relates to a wind turbine and to a wind farm.

### BACKGROUND

The prior art for offshore areas currently include wind turbines with a hub height of 100 m. In order to achieve a higher energy yield, the rotor area and/or the hub height must be increased. Modifying the hub height is advantageous because the wind acting on the rotor blades is distributed in a more homogenous (laminar) manner.

The current limit to the hub height of today's wind energy turbines is substantially determined by crane technology and crane length.

Rotor blades with a changeable rotor blade length have also previously been described. These rotor blades are generally referred to as telescopic rotor blades. The modifiable length of the rotor blades allows the energy yield to be adapted in a controllable and/or an adjustable manner.

The development of wind turbines over the last decades has shown that a higher wind yield or energy yield comes along with higher hub heights and/or rotor blade diameters. This meant that wind turbines had to be dimensioned for higher hub heights or greater rotor blade diameters, respectively. This resulted in higher costs and greater expenses with regard to materials such as foundations or supporting elements. The rule to date was “higher yield equals proportional or over-proportional dimensions of the turbine with regard to the expected (extreme) loads”.

In order to obtain the certification for a wind turbine, the wind turbine must be able to resist extreme loads, for example, a so-called 50-year wind event. Wind turbines with telescopic rotor blades and fixed length rotor blades must therefore be designed with regard to safety requirements so that a 50-year wind event will not cause damage to the wind turbine. This implies enormous material-related and safety-related expenses, which increases the costs for such a wind turbine.

### SUMMARY

An aspect of the present invention is to improve on the prior art.

In an embodiment, the present invention provides a rotor blade which includes a first rotor blade section, a second rotor blade section, a control device, and a reset device. The control device is configured to displace the first rotor blade section and the second rotor blade section relative to each other so as to form a telescopic rotor blade which can adopt a minimum position, an intermediate position or a maximum position. The reset device is configured so that, when the control device experiences a functional limitation, the telescopic rotor blade assumes the minimum position.

### BRIEF DESCRIPTION OF THE DRAWINGS

The present invention is described in greater detail below on the basis of embodiments and of the drawings in which:

FIG. 1 shows a schematic representation of a section of a telescopic rotor blade;

FIG. 2 shows a schematic lateral representation of a wind turbine with a hub height of 190 m; and

FIG. 3 shows a schematic lateral view of a wind turbine with a hub height of 100 m.

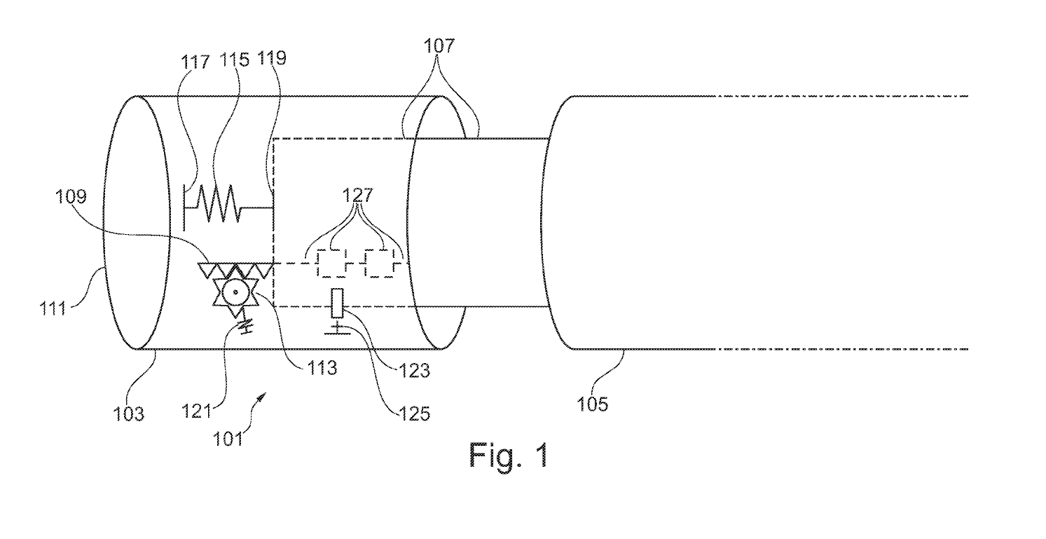

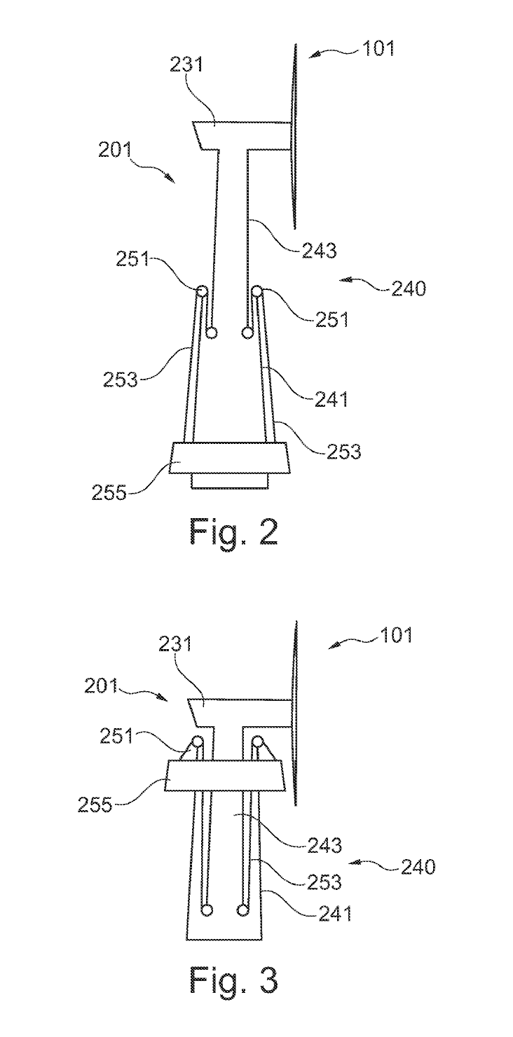

### DETAILED DESCRIPTION

A rotor blade can thus be provided which, in an emergency case, always remains or is brought into a minimum position. The safety requirements can thus be adapted to the minimum length instead of to the maximum length.

The rule according to which “higher yield equals proportional or over-proportional dimensions of the turbine with regard to the expected (extreme) loads” can thus be broken, resulting in a “decoupling of the yield from the dimensions of the turbine with regard to the expected (extreme) loads”. Only then can certain wind turbines be produced economically.

The following terms are hereby explained:

A “rotor blade section” is a (component) part of the rotor blade. The rotor blade sections are disposed so as to be “displaceable” relative to each other so that a telescopic rotor blade is provided whose contact surface with the wind can be modified in an adjustable manner. A rotor blade section is, for example, partially immersible in the other rotor blade section so that a sufficiently stable connection can be provided.

The displacement of the rotor blade sections relative to each other is carried out by means of a “control device”. This control device applies a rotational or translational movement to one of the rotor blade sections. In an embodiment, this is carried out by means of a pinion that engages with a rack. The control device can also be implemented by a roller drive such as those used in an elevator. Technologies, such as those used in a magnetic levitation method, can also be used.

When displacing the rotor blade sections, substantially three conditions, or three respective positions of the rotor blade sections relative to each other can be set.

In a “minimum position”, the rotor blade is at its minimum length. A further reduction of the length of the rotor blade is not realizable.

In a “maximum position”, the rotor blade is at its maximum length. A further displacement for lengthening the rotor blade cannot be implemented without destroying it.

“Intermediate position” herein refers to all positions between the minimum position and the maximum position.

The term “functional limitation of the control device” refers to all malfunctions and limitations of the control device. This can include the complete breakdown of the control device as well as a merely reduced output of the (control) motor.

The “reset device” builds up a force between the individual rotor blade settings which provides, from a technical standpoint, that the rotor blade sections will move into the minimum position. In an embodiment, the device is a tension spring which is fastened at each respective spring end to both rotor blade sections. Other alternatives, such as associated electromagnets, can, for example, also form the reset device.

In an embodiment, the reset device has a spring element with a spring force.

By means of this mechanical reset device, a return to a minimum position can be provided independently from a possible power supply.

The spring force can be greater than a (maximum) centrifugal force of an outer blade section and/or a force of the control device to provide that the reset device will securely displace the rotor blades into the minimum position independently from the rotational speed of the rotor blades.

In an embodiment, the control device includes a safety device.

The rotor blade sections can thus be locked relative to each other in the minimum position, in the intermediate position, and in the maximum position.

The “locking device” can have electrical and mechanical locking elements. An electrical locking element comprises an actuatable electromagnet and a mechanical locking element comprises a bolt which can, for example, be slid into a bolt opening. The locking elements themselves can also be controlled in a fail-safe manner so that, in case of a power breakdown, the locking device is automatically released. This can in turn be implemented by means of a reset device that is assigned to the locking device.

In order to provide that the reset device moves the rotor blade into a minimum position, the control device can have a safety device which releases a rotor blade section or several rotor blade sections in case it must be secured.

“Release” means, for example, that the reset device can move the rotor blade sections so that the rotor blade sections take up the minimum position. In an embodiment, the locking devices are released or a motor, which drives the pinion, is switched into a free-running mode or mechanically folded away, for example, as a result of magnets, so that the motor does not apply a force to the reset device.

In an embodiment, the rotor blade has other rotor blade sections and/or other control devices and/or other reset devices.

A rotor blade can thus be provided which is multiply extendable with respectively separate control devices and reset devices.

In an embodiment, the present invention provides a tower, for example, a wind turbine tower, with a first tower section and second tower section, wherein the first tower section and the second tower section are configured to be displaceable relative to each other by means of a control device so that, for example, a telescopic tower is formed so that the tower sections can adopt a minimum position, an intermediate position, or a maximum position when displaced, a reset device being provided which is set up so that, in case of a function limitation of the control device, the tower sections take up the minimum position.

A tower can thus be provided that can be securely moved into a minimum position even during an extreme event, such as, for example, a 50-year wind event. By taking up this minimum position, the energy capture of a wind turbine can be reduced.

The previously established rule “higher yield equals proportional or over-proportional dimensions of the turbine with regard to the expected (extreme) loads” can thus here too be broken resulting in a “decoupling of the yield from the dimensions of the turbine with regard to the expected (extreme) loads”. Only then can certain wind turbines be produced economically.

The tower additionally allows providing wind turbines, for example, for offshore areas, with a significantly increased hub height. Hub heights according to the prior art are currently limited to a height of approximately 100 m. With the present technology, an effective hub height of, for example, 300 m can be implemented. Considerably more efficient (offshore) wind turbines can thus be provided by means of current assembly technologies.

Reference is made to the definitions set forth above which also apply to the tower in an adapted form.

It must, however, here be taken into account that the reset device uses, for example, gravity so that spring elements which would, for example, pull the individual tower sections together, can be dispensed with.

In an embodiment, the tower can have a brake device which slows down and/or cushions a tower section on its way to the minimum position. It can thus be prevented that an upper tower section moves unchecked into a lower tower section.

The “brake device” can, for example, be configured as a gas pressure spring or an oil pressure spring with an end position damping arrangement.

The braking device can have a counterweight or a damping element in order to reduce the energy expense for a displacement of the tower sections relative to each other and to implement a braking effect.

In order to lock the tower sections relative to each other, the control device can have a “locking device”.

Regarding the locking device, reference is made to the above explanations which also apply to the tower in an adapted form.

In order to provide that the tower sections can be moved to the minimum position at any time, the control device can have a safety device which releases a tower section or several tower sections in case they need to be secured.

Reference is here too made to the previously given definitions regarding the safety device which also apply to the tower in an adapted form.

In an embodiment, the tower has other tower sections and/or other control devices and/or other reset devices.

A wind turbine tower can thus be provided which is extendable by more than twice its basic length and where a return to the respective minimum positions is provided in the case of an emergency.

In an embodiment, the present invention provides a wind turbine, for example, an offshore wind turbine, which has a previously described tower and/or a previously described rotor blade.

A wind turbine can thus be provided, for example, in offshore areas, whose hub height is much higher than 100 m and which can adjustably absorb a corresponding energy yield from the wind acting on it. The wind turbine can additionally control and/or regulate the energy capture of the generator by determining the height of the tower or the longitudinal extension of the rotor blades.

In an embodiment, the present invention provides a wind farm, for example, an offshore wind farm, which has a previously described wind turbine.

Effects appearing in wind farms can thus be minimized. Wind turbines standing in a row in the direction of the wind can, for example, be moved so that the first wind turbine in the direction of the wind is operated at a minimum height and a wind turbine standing behind it is operated at a maximum height so that possible turbulences caused by the first wind turbine do not impact or only slightly impact the wind turbine standing behind it.

Both wind turbines can nevertheless produce substantially the same energy yield since the first wind turbine in the direction of the wind is, for example, operated with rotor blades extended to a maximum position, and the wind turbine standing behind it is operated with rotor blades extended to a minimum position.

The present invention is hereinafter described in more detail based on exemplary embodiments as shown in the drawings.

A telescopic rotor blade 101 has a first rotor blade section 103 and a second rotor blade section 105. The first rotor blade section 103 is flangeable to a hub (not shown) of a wind turbine by means of a rotor blade flange 111. The second rotor blade section 105 has a pin 107, which is guided in the first rotor blade section 103.

A spring 115 has a first spring attachment 117, which is connected to the first rotor blade section 103 and a second spring attachment 119, which is connected to the pin 107 and thus to the second rotor blade section 105. In addition, a rack 109 is mounted on the pin 107. A pinion 113 engages with the rack 109.

The pinion 113 is firmly connected to the first rotor blade section 103 via a pinion spring 121. In addition, a control motor (not shown) is disposed on the rotational axis (not shown) of the pinion 113.

In addition, the pin 107 has several electromagnets 127 disposed next to each other. A permanently magnetic bolt 123, which is firmly connected to the first rotor blade section 103 via a bolt spring 125, is assigned to these electromagnets 127.

In general, the second rotor blade section 115 is moved into an operating position by the control motor and the pinion 113 and the assigned rack 109 against the spring force of the rotor blade spring 115.

In order to move the second rotor blade section 105 into the minimum position of the telescopic rotor blade 101, the pin 107 is completely admitted into the first rotor blade section 103.

Providing that the minimum position is taken up can be achieved cumulatively or alternately as follows:

The control motor (not shown) connected to the pinion is switched into an idle position. The rotor blade spring 115 thereby pulls the second rotor blade section 105 and thus the spring 107 completely into the first rotor blade section 103.

In addition, by switching off an electromagnet, the pinion 113 can be “folded away” by the spring 121 under the action of the pinion spring 121, so that the pinion 113 has no active contact with the rack 109. In this case, the rotor blade spring 115 also pulls the second rotor blade section 105 together with the pin 107 entirely into the first rotor blade section 103.

By means of the bolt 123, the pin 107 can be fastened to the first rotor blade section 103. To this end, one of the electromagnets 127 is actuated so that the bolt 123 is pulled into a locking seat (not shown).

In case the telescopic rotor blade 101 must be moved into the minimum position, the power supply of the electromagnets is interrupted and the bolt spring 125 pulls the bolt 123 out of the locking seat so that the second rotor blade section 105 with its assigned pin 107 is free and the second rotor blade section 105 is entirely admitted in the first rotor blade section 103.

The operation of a telescopic tower is explained in more detail based on a wind turbine 201.

A wind turbine 201 has a telescopic tower 240 with a nacelle 231 disposed at the top and rotor blades 101 flange-mounted onto a hub.

The telescopic tower 240 includes a lower tower section 241 and an assigned upper tower section 243, wherein the upper tower section 243 is at least partially retractable inside the lower tower section 241. The lower tower section 241 and the upper tower section 243 are displaceable relative to each other by way of a tower drive 251, which is configured like an elevator drive. In addition, a counterweight 255 attached to a retaining cable 253 is provided.

The counterweight 255 has a somewhat lesser mass than the upper tower section 243 including the nacelle 231 and the telescopic rotor blades 101, so that a slow displacement of the upper tower section 243 with its superstructures is implementable.

As a rule, in order to optimize the energy yield, the wind turbine is operated with an extended upper tower section 243. A substantial adjustment is carried out by way of the telescopic rotor blades 101.

In case the wind turbine must be moved into a minimum position, the tower drive 251 is switched into an idle position. In this case, the counterweight 255 is lifted and the upper tower section 243 is lowered into the lower tower section 241. In the present, the safety mechanisms of the telescopic rotor blade can also be used in an analogous manner for the two tower sections 243, 241.

The present invention is not limited to embodiments described herein; reference should be had to the appended claims.

### LIST OF REFERENCE NUMBERS

101 telescopic rotor blade
103 first rotor blade section
105 second rotor blade section
107 pin
109 rack
111 rotor blade flange
113 pinion
115 spring
117 first spring attachment
119 second spring attachment
121 pinion spring
123 bolt
125 bolt spring
127 electromagnet
201 wind turbine
231 nacelle
240 tower
241 lower tower section
243 upper tower section
251 tower drive
253 retaining cable
255 counterweight

What is claimed is:

1-14. (canceled)

15. A rotor blade comprising:
a first rotor blade section;
a second rotor blade section;
a control device configured to displace the first rotor blade section and the second rotor blade section relative to each other so as to form a telescopic rotor blade which can adopt a minimum position, an intermediate position or a maximum position; and
a reset device configured so that, when the control device experiences a functional limitation, the telescopic rotor blade assumes the minimum position.

16. The rotor blade as recited in claim 15, wherein the reset device comprises a spring element comprising a spring force.

17. The rotor blade as recited in claim 16, wherein
the outer rotor blade section comprises a centrifugal force and the control device comprising a control device force, and
the spring force is greater than at least one of the centrifugal force and the control device force.

18. The rotor blade as recited in claim 15, wherein the control device comprises a locking device.

19. The rotor blade as recited in claim 15, wherein the control device comprises a safety device configured to release at least one of the first rotor blade section and the second rotor blade section in case the at least one of the first rotor blade section and the second rotor blade section need to be secured.

20. The rotor blade as recited in claim 15, further comprising at least one of an other rotor blade section, an other control device, and an other reset device.

21. A tower comprising:
a first tower section;
a second tower section;
a control device configured to move the first tower section and the second tower section relative to each other so as to form a telescopic tower which can adopt a minimum position, an intermediate position or a maximum position; and
a reset device configured so that, when the control device experiences a functional limitation, the telescopic tower assumes the minimum position.

22. The tower as recited in claim 21, wherein the tower is a wind turbine tower.

23. The tower as recited in claim 21, further comprising a braking device configured to at least one of slow down and cushion at least one of the first tower section and the second tower section when the telescopic tower assumes the minimum position.

24. The tower as recited in claim 23, wherein the braking device comprises at least one of a counterweight and a damping element.

25. The tower as recited in claim 21, wherein the control device comprises a locking device.

26. The tower as recited in claim 21, wherein the control device comprises a safety device configured to release at least one of the first tower section and the second tower section in case the at least one of the first tower section and the second tower section need to be secured.

27. The tower as recited in claim 21, further comprising at least one of an other tower section, an other control device, and an other reset device.

28. A wind turbine comprising at least one of a tower and a rotor blade, wherein the tower comprises:
a first tower section; and
a second tower section;
a control device configured to move the first tower section and the second tower section relative to each other so as to form a telescopic tower which can adopt a minimum position, an intermediate position or a maximum position; and
a reset device configured so that, when the control device experiences a functional limitation, the telescopic tower assumes the minimum position, and the rotor blade comprises:
a first rotor blade section;
a second rotor blade section;
a control device configured to displace the first rotor blade section and the second rotor blade section relative to each other so as to form a telescopic rotor blade which can adopt a minimum position, an intermediate position or a maximum position; and
a reset device configured so that, when the control device experiences a functional limitation, the telescopic rotor blade assumes the minimum position.

29. The wind turbine as recited in claim 28, wherein the wind turbine is an offshore wind turbine.

30. A wind farm comprising the wind turbine as recited in claim 29.

31. The wind farm as recited in claim 30, wherein the wind farm is an offshore wind farm.
